(19) United States
(12) Patent Application Publication
(10) Pub. No.: US 2026/0169565 A1
(43) Pub. Date: Jun. 18, 2026

(54) HAPTIC INTERFACE WITH COUPLING OF EFFECTS

(71) Applicant: COMMISSARIAT A L'ENERGIE ATOMIQUE ET AUX ENERGIES ALTERNATIVES, PARIS (FR)

(72) Inventors: Théotime GOUBAULT, GRENOBLE CEDEX 09 (FR); Fabrice CASSET, GRENOBLE CEDEX 09 (FR)

(73) Assignee: COMMISSARIAT A L'ENERGIE ATOMIQUE ET AUX ENERGIES ALTERNATIVES, PARIS (FR)

(21) Appl. No.: 19/423,019

(22) Filed: Dec. 17, 2025

(30) Foreign Application Priority Data
Dec. 18, 2024 (FR) FR2414513

(51) Int. Cl. G06F 3/01; B06B 1/06; G06F 3/041

(52) U.S. Cl. CPC G06F 3/016; B06B 1/06; G06F 3/0414

(57) ABSTRACT

The invention concerns a haptic interface comprising a haptic structure defining a touch surface able to be touched by a user, the haptic structure comprising a plate comprising a lower surface, and an upper surface able to be touched by a user; at least one Lamb piezoelectric actuator coupled to the plate and configured to cause the plate to vibrate in a so-called Lamb vibration mode, the vibration being able to propagate in the plate to cause the plate to vibrate uniformly, the vibration in a Lamb mode having regions of maximum vibration and regions of zero amplitude, nodal lines being defined on the plate (2) where the amplitude of the vibrations is minimal; an array of non-radiating piezoelectric actuators coupled to the plate, each non-radiating piezoelectric actuator of the array being configured selectively and locally to generate a deformation of the plate.

### TECHNICAL FIELD

The invention relates to the field of human-machine interfaces and more particularly those producing haptic effects.

### PRIOR ART

A haptic interface allows a user to interact with the environment via the sense of touch. Haptic feedback is currently used in numerous applications, e.g. on smartphones which generate a slight vibration when a user presses on a key displayed on the screen to simulate the impression of pressing on a physical button for example.

With the emergence of touch screens (capacitive or resistive), there has been a large increase in haptic applications.

This technology for example can provide better immersion in video games. It can allow facilitated purchasing of clothes on the Internet with the possibility of virtually touching items by means of a computer. The sector of smartphones or PC tablets is also concerned with the possible addition of virtual keys or keypads.

Haptics have relevance as part of medical training, in hazardous industries (chemical or nuclear handling operations). The automotive sector can also be cited as major field of application with the possibility of inserting haptic buttons on the dashboard. Drivers could therefore obtain haptic information confirming an action on the dashboard, while remaining focused on the roadway . . .

It is known to generate haptic effects using piezoelectric actuators which generate vibration modes or ensure the propagation of an ultrasound wave in the interface.

Said effects are generated either by causing the entire interface to vibrate and in this case the effect is the same in every part and is termed <<single-touch>> (if several fingers are applied, they will each perceive the same feel). In this case it will be possible to cause a continuous effect, but only the same effect will be felt over the entire interface at a given time t.

Or the effect is localised in which case it will be <<multi-touch>> and each finger locally will potentially feel a different effect. In this case, the effect is localised and for continuity thereof the interface must either drive an array of pre-calibrated actuators at each instant to generate an adapted effect under the moving fingers, or it must be provided with a very large number of piezoelectric actuators which raises problems of integration.

### SUMMARY OF THE INVENTION

The invention proposes solving at least one of these shortcomings.

For this purpose, in a first aspect, the invention proposes a haptic interface comprising:
a haptic structure defining a touch surface able to be touched by a user, the haptic structure comprising:
a plate comprising a lower surface, and an upper surface that is able to be touched by a user;
at least one Lamb piezoelectric actuator coupled to the plate and configured to cause the plate to vibrate in a so-called Lamb vibration mode, the vibration being able to propagate in the plate to cause uniform vibration of the plate, the vibration in a Lamb mode having regions of maximum vibration and regions of zero amplitude, nodal lines being defined on the plate where the amplitude of the vibrations is minimal;
an array of non-radiating piezoelectric actuators coupled to the plate, each non-radiating piezoelectric actuator of the array being configured selectively and locally to generate a deformation of the plate; the non-radiating piezoelectric actuators being distributed over the lower surface of the plate such as not to perturb the Lamb mode vibration;
a control unit configured to produce and send signals to the non-radiating piezoelectric actuators and to the Lamb piezoelectric actuator as a function of a haptic effect to be obtained, so as to obtain a haptic effect by a modulation of the localised friction coefficient.

The invention is advantageously complemented with the following characteristics taken alone or in any technically possible combination thereof:
the non-radiating piezoelectric actuators are distributed over the lower surface such that they are disposed on nodal lines of the generated Lamb mode;
the non-radiating piezoelectric actuators occupy a surface area having a width, taken between two antinodes of the Lamb vibration mode, of less than one half-wavelength of the Lamb vibration mode;
the non-radiating piezoelectric actuators are distributed over the lower surface such that they are disposed on antinodal lines of the generated Lamb mode, the non-radiating piezoelectric actuators having a width taken in the direction of propagation of vibration greater than or equal to a half-wavelength of the Lamb vibration mode;
two non-radiating piezoelectric actuators are spaced apart by a distance greater than the size of a finger of between 0.5 and 2 cm edge-to-edge, and by a centre-to-centre distance which is a multiple of a half-wavelength;
the non-radiating piezoelectric actuators are circular or hexagonal;
the non-radiating piezoelectric actuators are disposed at a distance greater than or equal to a half-wavelength from a Lamb piezoelectric actuator.

In a second aspect, the invention proposes a method for generating at least one haptic effect capable of being felt by a user in contact with a haptic interface according to the first aspect of the invention, comprising the following steps:
detecting at last one position of at least one contact by a user on the surface of the plate;
sending at least one control signal to the piezoelectric and Lamb actuators as a function of the detected position or positions, to cause the plate to vibrate uniformly in a Lamb mode and locally by at least one piezoelectric actuator.

The method in the second aspect is such that the vibration in a Lamb mode and the vibration of the piezoelectric actuators generate a variation in the friction coefficient perceptible to the touch of a user moving a finger over the surface of the plate.

The method in the second aspect is such that the control signal is configured so that the plate vibrates uniformly in a Lamb mode at an amplitude greater than a few 100 nm, preferably between 100 nm and 2 μm, or between 100 nm and 1 μm.

The advantages of the invention are numerous.

The haptic interface allows the generating of a haptic effect via the modulation of the friction coefficient obtained by coupling of a Lamb mode with non-radiating waves.

The use of a Lamb mode allows the generating of a continuous effect over the entire interface. In this case, all the surface vibrates identically and therefore proposes the same uniform sensation.

The use of non-radiating waves allows the generating of one or more localised effects in the vicinity of the actuators. In this case, it is possible to generate a multi-touch effect that is different for each finger in contact with the plate.

In one particular embodiment, the positioning of the non-radiating piezoelectric actuators on nodal lines—by actuating at the same time one or more non-radiating piezoelectric actuators during uniform vibration of the plate—allows a continuous effect to be obtained on the plate whilst allowing multi-touch.

In the interface of the invention, the haptic effects obtained by non-radiating waves are discrete and with low resolution (to avoid having a density of non-radiating actuators that is too high, which would raise a problem of integration), this being offset by an effect obtained using a stationary Lamb mode to ensure continuous haptic effects on the interface.

### PRESENTATION OF THE FIGURES

Other characteristics, objectives and advantages of the invention will become apparent from the following description which is solely illustrative and nonlimiting and is to be read in connection with the appended drawings in which:

FIG. 1 illustrates a side view of a haptic interface according to one embodiment.

FIG. 2 gives an overhead view of a haptic interface according to one embodiment.

FIG. 3 illustrates several arrangements of so-called Lamb piezoelectric actuators around a plate able to vibrate in a Lamb vibration mode.

FIG. 4 illustrates a possible arrangement of so-called Lamb piezoelectric actuators.

FIG. 5 illustrates the impact of the position of the non-radiating actuators on the Lamb mode.

FIG. 6 illustrates several vibration states in a Lamb mode.

FIG. 7 illustrate steps of a method for generating at least one haptic effect by means of the interface subject of the present disclosure.

FIG. 8 illustrates a possible functioning of the interface subject of the present disclosure.

In all the Figures similar elements carry same references.

### DETAILED DESCRIPTION

### General Presentation of the Haptic Interface

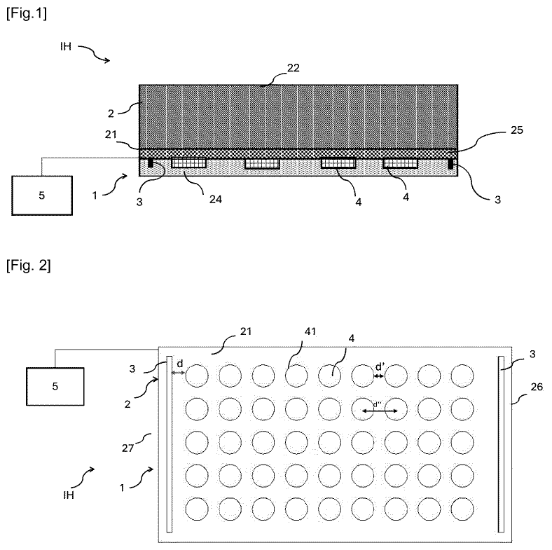

FIGS. 1 and 2 give a cross-sectional view and front view of a haptic interface IH according to one embodiment of the invention.

The haptic interface IH comprises a haptic structure 1 comprising a plate 2 defining a touch surface able to be touched by a user. Said plate 2 is a screen for example and is preferably rectangular. The surface 2 comprises a lower surface 21 and an upper surface 22. The screen is an OLED screen for example.

The haptic interface comprises piezoelectric actuators of two types which allow 1) causing the plate 2 to vibrate in a so-called Lamb resonance mode, 2) selectively and locally generating a deformation of the plate 2 by means of vibration modes at non-radiating frequencies.

The haptic interface in this respect comprises at least one Lamb piezoelectric actuator 3 (hereafter Lamb actuator) and at least one non-radiating piezoelectric actuator 4 (hereafter non-radiating actuator). The piezoelectric actuators 3, 4 are disposed underneath the lower surface 21 of the plate 2/screen.

The idea of the invention is to couple two types of vibrations to generate a complex haptic effect which combines two haptic principles: that of modulation of the friction coefficient from a Lamb mode which produces a continuous effect but which is the same over the entire interface (single-touch effect) and that of non-radiating waves which generate one or more discrete effects on the plate (multi-touch effect). The combination of these two effects allows the generating of multi-touch, localised haptic effects whilst having a continuous effect.

It is then possible to obtain a modulation of the friction coefficient in localised manner. This localised modulation of the friction coefficient is made possible only by the non-radiating waves. The Lamb mode generated by the Lamb actuators 3 adds contrast when needed and allows the filling of dead regions between two non-radiating actuators 4. This provides an effect perceived as being continuous whilst reducing the density of non-radiating actuators NR, which has many advantages.

A unit detecting the position of the user's fingers with the interface is also provided. This can be formed by piezoelectric actuators (non-radiating or Lamb) or else by a capacitive sensing interface optionally included in the plate 2/screen.

A control unit 5 is connected to each Lamb actuator 3 and each non-radiating actuator 4 by means of metal traces (not illustrated) and optionally to the unit detecting the position of the fingers. The control unit 5 generates and sends signals able to actuate each piezoelectric actuator 3, 4 thereby ensuring driving of the haptic interface 1. The control unit 5 is configured to allow actuation at high frequency (typically at several tens of kHz even several hundred kHz for the Lamb actuators, and at least several hundred kHz for the non-radiating actuators even several tens khz) and optionally an amplitude modulation of this signal to produce an effect perceptible by a user. The Lamb actuators 3 do not need to be independent but the non-radiating actuators 4 must be able to be actuated independently.

The plate 2 is preferably rectangular and, being a screen, it allows the display of images to improve user experience of the haptic interface described herein.

Optionally, the piezoelectric actuators 3, 4 are arranged on a passivation layer 24 and optionally under a polymer sheet 25 between the piezoelectric actuators and the lower surface 21 of the plate 2.

### Lamb Piezoelectric Actuator 3

At least one Lamb piezoelectric actuator 3 is coupled to the plate 2 and is configured to cause the plate/screen/cover to vibrate in a so-called Lamb resonance mode. In known manner, Lamb modes are present in solids whenever one dimension is much smaller than the two others. The profile of antisymmetric Lamb modes is used to generate a haptic effect via variation in friction (i.e. for vibration frequencies higher than or equal to 20 kHz with amplitudes greater than or equal to 1 μm). By making use of a resonance, the displacement amplitude is maximised relative to the energy used to initiate the displacement. Therefore, at least one Lamb actuator 3 is controlled to generate vibrations in a Lamb mode able to propagate uniformly through the plate 2 over the entire surface 21 thereof. Each Lamb actuator 3 is disposed underneath the lower surface 21 of the plate 2/screen. As is known, Lamb waves have vibration points of maximum amplitude (antinodes) and points of zero or near-zero amplitude (nodes). In this manner, it is possible to define antinodal lines on the lower surface 21 of the plate 2 where the amplitude of vibrations is maximum. Conversely, nodal lines are lines where the amplitude of the vibrations of the plate 2 is near-zero even zero (at all events minimal relative to the maximum amplitude).

To generate a vibration in Lamb mode, the haptic interface comprises at least one rectangular Lamb actuator 3 disposed along at least one side 26, 27 of the plate 2 (along the small side of the rectangle) underneath the lower surface 21 thereof.

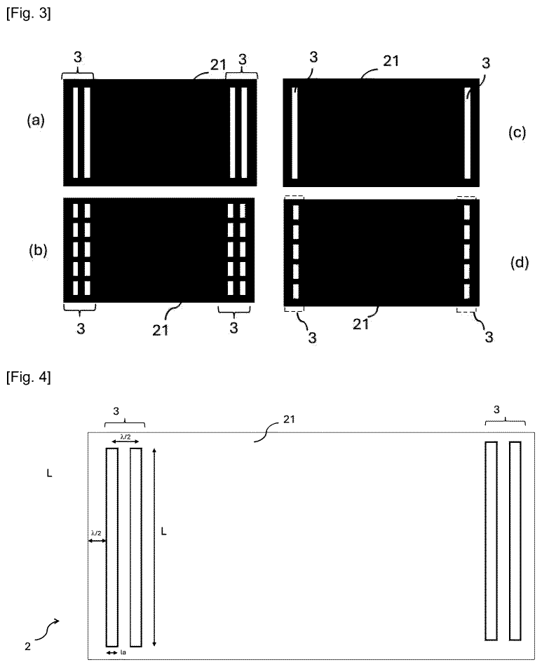

FIG. 3 illustrates several possibilities for positioning at least one Lamb actuator 3:
(a) two rectangular Lamb actuators 3 disposed either side of the plate 2;
(b) two columns of five rectangular Lamb actuators 3 either side of the plate 2;
(c) one rectangular Lamb actuator 3 disposed either side of the plate 2;
(d) one column of five rectangular Lamb actuators 3 either side of the plate 2.

Preferably, <<large>> rectangles are to be preferred as in configurations (a) and (c) above.

Also preferably, the Lamb actuator 3 covers the entire width of the plate.

As illustrated in FIG. 4, the Lamb actuator 3 is positioned at a half-wavelength from the edge of the plate so as to lie on a vibration antinode, and in the configuration with 4 actuators (2×2 columns) they lie distant by a half-wavelength (i.e. in phase opposition). Alternatively, they can lie distant by a wavelength from the edge of the plate to be in phase, but to the detriment of effective surface area for the non-radiating actuators 4.

To optimise the displacement produced by the Lamb actuators 3, the actuator width <<la>> must be less than a half-wavelength to optimise the efficacy thereof. For a Lamb mode having a wavelength of 14 mm (e.g. on a rectangular plate 127 by 70 mm², of thickness 0.7 mm, considering a Lamb mode at 36 kHz), <<la>> must be less than 7 mm, for example therefore between 2 and 6 mm, and preferably 5 mm to optimise the surface/displacement ratio.

In one embodiment, the Lamb actuators 3 allow the generating for example of a Lamb mode at 36 kHz corresponding to a wavelength of 14 mm. This frequency is compatible with the generation of a haptic effect. However, to generate a haptic effect using a Lamb mode, it is known to use modes at a frequency ranging from 20 kHz up to several hundred kHz, typically 100 kHz. In this case, the corresponding wavelengths will be from 5 mm to 20 mm, and for continuity of the effect wavelengths of less than 20 mm will be chosen. High frequencies, of several tens of kHz, up to a few hundred kHz, typically 200 to 300 kHz, are to be preferred since the intensity of modification of the friction coefficient is dependent on frequency. (Reference can be made in this respect to the following document highlighting the fact that an increase in frequency induces an increase in intensity of the effect: F. Giraud, T. Hara, C. Giraud-Audine, M. Amberg, B. Lemaire-Semail, and M. Takasaki, <<Evaluation of a friction reduction based haptic surface at high frequency>>, in 2018 IEEE Haptics Symposium (HAPTICS), March 2018, p. 210-215. doi: 10.1109/HAPTICS.2018.8357178.).

In addition, to be perceptible by the user, the actuation signal of the Lamb mode is modulated at low frequency, from 10 to 1000 Hz. Additionally, as a function of the desired sensation, preference can be given to frequencies ranging from 250 to 350 Hz representing the frequency domain of maximum sensitivity for the finger.

### Non-Radiating Piezoelectric Actuators 4

An array of non-radiating actuators 4 is coupled to the plate 2. Each non-radiating actuator 4 is disposed underneath the lower surface 21 of the plate 2/screen and is configured selectively and locally to generate a deformation of the plate 2. In particular, the non-radiating actuator 4 deforms the plate 2 in the region of the effect thereof defined by its size. For example, in FIG. 2, the non-radiating actuator 4 is adapted to deform the plate 2 at the surface delimited by a circle.

Each non-radiating actuator 4 is preferably bonded to the lower surface 21 of the plate 2 and produces point radial forces on the actuator outer edge 41. These radial forces give rise to vibration modes in the plate 2. Some vibration modes generated in the plate 2 are exponentially attenuated very rapidly, moving radially away from the source. These modes belong to these frequency domains of «non-radiating frequencies ». By exciting a non-radiating actuator 4 at a non-radiating frequency, the sensation can be localised within a short radius around the non-radiating piezoelectric actuator 4.

By laying an array of non-radiating actuators 4 on the upper surface 22 of the plate 2, a localised haptic sensation is obtained over a large surface area.

Advantageously, the maximum distance between two non-radiating actuators 4 taken edge-to-edge 41, denoted d′ in FIG. 2, corresponds to the size of a finger namely about 1 cm (approximate width of a finger). The distance <<d>> taken centre-to-centre is greater than or equal to a half-wavelength and is a multiple of the half-wavelength of the Lamb mode.

Said distance is defined in relation to issues of integration, connectors, or continuity of the haptic sensation.

The non-radiating actuators 4 are sized in relation to the profile of the Lamb mode to avoid perturbing the Lamb mode.

In one preferred embodiment, the non-radiating actuator 4 has a maximum width between two antinodes of the Lamb mode vibration of less than one half-wavelength of the Lamb vibration mode (typically less than or equal to 2/5 of the wavelength). In this case, the non-radiating piezoelectric actuators 4 are distributed such that they are disposed on nodal lines LN of the generated Lamb mode. That is to say on amplitude minima where stresses are the weakest, for least possible perturbation of the Lamb mode.

In other words, the non-radiating actuators 4 are sized in relation to the profile of the Lamb mode so that their periphery always lies away from the antinodal lines (or antinodes) where the amplitude of the Lamb mode vibration is at its maximum. The purpose is to obtain the least possible perturbation of Lamb mode vibration. Therefore, to ensure the continuity of the haptic effect, the non-radiating actuators 4 are positioned on the nodal lines without the edges touching the antinodal lines. They lie at a distance (d in FIG. 2) configured to allow forming of the vibration wavefront in Lamb mode.

In a second embodiment, each non-radiating actuator 4 has a maximum width, taken in the direction of propagation of vibration, greater than or close to one half-wavelength of the Lamb vibration mode (from 2/5 of the wavelength up to one wavelength at most). In this embodiment, the non-radiating piezoelectric actuators 4 are distributed over the lower surface 21 such that they are disposed on antinodal lines LA of the generated Lamb mode.

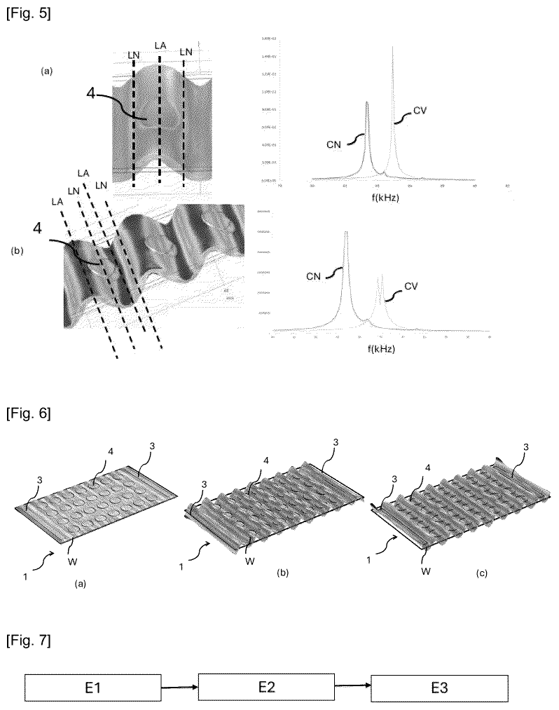

FIG. 5 illustrates (a) the effect of positioning a non-radiating actuator 4 on an antinodal line LA and (b) the effect of positioning a non-radiating actuator 4 on a nodal line LN for a non-radiating actuator 4 having a diameter close to one half-wavelength (in the Figure, the wavelength is 8.88 mm and the diameter is 4 mm, therefore the diameter is about 45% of the wavelength). Curves can be seen on the right showing the amplitude of vibration at the antinode (curve CV) and the amplitude of vibration at the node (CN); it can be seen in this case, where there is a diameter less than but close to a half-wavelength of the Lamb mode and where the non-radiating actuator 4 is positioned on an antinodal line LA, that the amplitude of the vibration at the antinode is less perturbed by the non-radiating actuator 4 only when it is placed on a nodal line. As indicated in this FIG. 5, it can be seen that if the actuator projects onto a vibration antinode, there will be an onset of stress concentration due to the amplitude of Lamb mode vibration on the periphery of the non-radiating actuator 4.

Irrespective of embodiment, the non-radiating actuators must be as thin as possible to obtain the least possible rigidifying of the plate 2. The thickness of the non-radiating actuators is between 2 μm and 300 μm preferably around 50 μm. This thickness is dependent on the material of the plate 2, the material of the actuators, the radius thereof and on the wavelength of the Lamb mode used. In general, to remain within the plate theory describing the Lamb mode, the total thickness (plate and actuators) must be negligible compared with the other dimensions. In theory, there is no link between the thickness of the Lamb actuators and the thickness of the non-radiating actuators. The thickness of the Lamb actuators is preferably between 2 μm and 500 μm.

Preferably, the non-radiating actuators 4 lie at a distance <<d>> at least equal to a half-wavelength λ/2 away from the Lamb actuators 3.

For example, the non-radiating actuators 4 must be as small as possible, ideally having a planar dimension ranging from a diameter (or side) of 1 mm to 1.4 cm, preferably from 5 mm to 1 cm.

FIG. 6 illustrates vibrations W propagated over the plate 2 by two Lamb actuators 3.

A non-radiating actuator 4 can have several shapes: circular or hexagonal.

In one preferred embodiment the haptic interface comprises non-radiating actuators 4 of diameter 1 cm corresponding to a non-radiating frequency at 120 kHz when the plate 2 is an OLED glass screen.

It will be noted that the non-radiating frequencies are much dependent on the material, the thickness of the screen and the dimensions of the non-radiating actuators 4. It is subsequently by modulating the effect at low frequency that it is possible to generate different sensations, as for the Lamb mode. It can be said that a <<rough>> texture is obtained at between 10 and 100 Hz becoming finer above 100 Hz and up to 1000 Hz. The perceived roughness depending on vibration amplitude. In this case, the actuators have non-radiating behaviour, allowing the generation of a localised haptic effect at a frequency ranging from 30 kHz to 1.3 MHz for actuators 4 of between 3 mm and 2 cm in diameter (frequency inversely proportional to the square of the diameter of the actuator). The range of frequencies being from 120 kHz to 480 kHz for non-radiating actuators 4 of between 5 mm and 1 cm in diameter.

### Method for Generating at Least One Haptic Effect

At a first step, the position of the user finger or fingers is detected (step E1).

Next, as a function of the haptic effect to be produced, the control unit generates (step E2) and sends (step E3) a control signal adapted to the piezoelectric actuator(s) concerned, to generate an effect by modulation of the friction coefficient.

The Lamb piezoelectric actuators 3 will receive a control signal which will apply a potential difference between their upper electrode and lower electrode in the form of a complex signal. This complex signal will be an alternating signal at a frequency corresponding to the size of the interface and the effect to be generated.

By actuating the actuators of the array of non-radiating actuators 4, the interface will then generate a localised effect on the position thereof, solely independently of or at the same time of the effect by modification of the friction coefficient generated by the Lamb actuators. Each non-radiating actuator 4 can be actuated independently and can therefore be actuated in the same manner as another actuator or differently.

For either one effect, the criterion for creating the friction modification effect is that a vibration amplitude of at least 1 μm is required and at least at 20 kHz (potentially less than1 μm if the frequency is increased). For the Lamb mode, a half-wavelength of 1 cm at most is needed to ensure that the finger is still in contact with maximum amplitude.

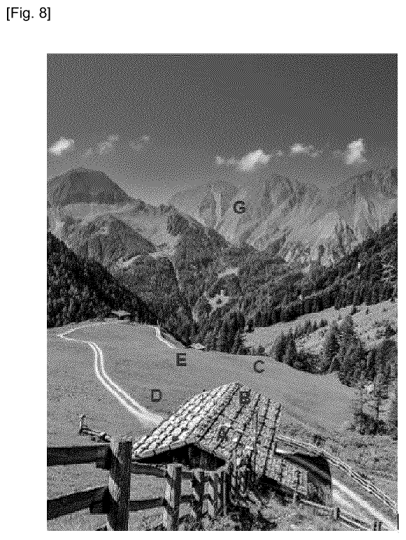

FIG. 8 shows an image displayed on the interface of the present description. The principle is the following: let there be a finger at A and a second finger at D. The non-radiating actuators 4 corresponding to region A will be actuated by a low frequency signal and those in region D by a signal of higher frequency generating a smooth effect. When the finger moves from A to B, the non-radiating 4 and Lamb actuators 3 can generate an effect by modifying the friction coefficient with frequency modulation of low frequency to generate a continuous rough effect. On the contrary, when the finger moves from D to E, the Lamb actuators 3 can generate an effect by modifying the friction coefficient with frequency modulation of higher frequency to generate a continuous smooth effect. To move from B to C, the non-radiating actuators 4 can generate different effects, by actuating the non-radiating actuator 4 close to region B differently from the one close to region C. At F, the signal addressed to the non-radiating actuators 4 will have an intermediate modulation frequency between those of points D and A, and at G it will be slightly higher but lower than that of point A. This allowing the generation of effects of greater or lesser roughness. Coupling with the image enhances the sensation.

It is shown here that various modifications of the friction coefficient are obtained on the interface as a function of the different points of contact.

1. A haptic interface comprising:
a haptic structure (1) defining a touch surface able to be touched by a user, the haptic structure (1) comprising
a plate (2) comprising a lower surface (21), and an upper surface (22) that is able to be touched by a user;
at least two Lamb piezoelectric actuators (3) configured to cause the plate (2) to vibrate in a so-called Lamb vibration mode, the vibration being able to propagate in the plate (2) to cause the plate (2) to vibrate uniformly, the vibration in a Lamb mode having regions of maximum vibration and regions of zero amplitude, nodal lines being defined on the plate (2) where the amplitude of the vibrations is minimal;
an array of non-radiating piezoelectric actuators (4) coupled to the plate, each non-radiating piezoelectric actuator (4) of the array being configured selectively and locally to generate a deformation of the plate (2);
the non-radiating piezoelectric actuators (4) being distributed over the lower surface (21) of the plate (2) on nodal or antinodal lines of the generated Lamb mode such as not to perturb the Lamb vibration mode;
a control unit (5) configured to produce and send signals to the non-radiating piezoelectric actuators (4) and to the Lamb piezoelectric actuator (3) as a function of a haptic effect to be obtained, so as to obtain a haptic effect by a modulation of the localised friction coefficient.

2. The haptic interface according to claim 1, wherein the plate is rectangular and the Lamb piezoelectric actuators (3) are disposed either side of the plate along the width of the plate (2)

3. The haptic interface according to claim 1, wherein the non-radiating piezoelectric actuators (4) are distributed on nodal lines, the non-radiating piezoelectric actuators (4) occupy a surface area having a width, taken between two antinodes of the Lamb mode vibration, of less than one half-wavelength of the Lamb vibration mode.

4. The haptic interface according to claim 1, wherein the non-radiating piezoelectric actuators (4) are distributed over the lower surface (21) on antinodal lines (LA) of the generated Lamb mode, the non-radiating piezoelectric actuators (4) having a width, taken in the direction of propagation of the vibration, greater than or equal to one half-wavelength of the Lamb vibration mode.

5. The haptic interface according to claim 1, wherein two non-radiating piezoelectric actuators (4) are spaced apart by a distance greater than the size of a finger of between 0.5 and 2 cm edge-to-edge, and by a centre-to-centre distance which is a multiple of a half-wavelength.

6. The haptic interface according to claim 1, wherein the non-radiating piezoelectric actuators (4) are circular or hexagonal.

7. The haptic interface according to claim 1, wherein the non-radiating piezoelectric actuators (4) are disposed at a distance greater than or equal to one half-wavelength away from a Lamb piezoelectric actuator (3).

8. A method for generating at least one haptic effect capable of being felt by a user in contact with a haptic interface such as defined in claim 1, comprising the following steps:
detecting (E1) at least one position of at least one contact of a user on the surface (22) of the plate (2);
sending (E2) at least one control signal to the non-radiating (4) and Lamb (3) piezoelectric actuators as a function of the detected position or detected positions to cause the plate (2) to vibrate uniformly in a Lamb mode and in localised manner by at least one piezoelectric actuator (4).

9. The method according to claim 8, the vibration in a Lamb mode and the vibration of the piezoelectric actuators (4) generate a variation in the friction coefficient perceptible to the touch of a user moving a finger over the surface of the plate (2).

10. The method according to claim 8, wherein the control signal is configured so that the plate vibrates uniformly in a Lamb mode at an amplitude greater than a few 100 nm, preferably between 100 nm and 2 μm, or between 100 nm and 1 μm.
